(19) United States
(12) Patent Application Publication
(10) Pub. No.: US 2008/0155099 A1
(43) Pub. Date: Jun. 26, 2008

(54) REPRODUCING APPARATUS, REPRODUCING SYSTEM, AND REPRODUCING METHOD

(76) Inventor: Deok-Gun PARK, Seoul (KR)

Correspondence Address: CANTOR COLBURN, LLP, 20 Church Street, 22nd Floor, Hartford, CT, 06103, US

(21) Appl. No.: 11/959,862

(22) Filed: Dec. 19, 2007

(30) Foreign Application Priority Data
Dec. 20, 2006 (KR) 10-2006-0130888

(51) Int. Cl. G06F 15/173

(52) U.S. Cl. 709/225

(57) ABSTRACT

A reproducing apparatus, a reproducing system, and a reproducing method are provided. The reproducing system includes a reproducing apparatus for having a unique product ID code and reproducing contents; and a management server for matching at least one podcast to the product ID code and providing download information based on the at least one podcast to the reproducing apparatus. The reproducing apparatus sends the product ID code to the management server and downloads the contents from a content server based on the download information. Accordingly, even a user with little knowledge about the podcast can replay and enjoy podcast audio and video contents with ease and convenience.

### PRIORITY

This application claims priority under 35 U.S.C. §119(a) to an application filed in the Korean Intellectual Property Office on Dec. 20, 2006, and assigned Serial No. 10-2006-0130888, the disclosure of which is herein incorporated by reference.

### BACKGROUND OF THE INVENTION

1. Field of the Invention

The present invention relates generally to a reproducing apparatus, a reproducing system, and a reproducing method. More particularly, the present invention relates to a reproducing apparatus, a reproducing system, and a reproducing method for reproducing downloadable audio and video contents.

2. Description of the Related Art

Recently, with advances of Internet and portable reproducing apparatuses, a podcast is attracting much attention. The podcast is a portmanteau of the words ‘iPOD’ and ‘broadcasting’ of the Apple. The podcast offers various contents such as news or soap operas to users of the portable reproducing apparatus such as computer, Portable Multimedia Player (PMP), and MP3 player (MP3P) in the form of an audio file or a video file. Unlike the existing radio broadcasting, the podcast is a new personal customized medium enabling the user to download and enjoy an automatically updated program of interest at any time without having to listen to the program on a scheduled time. Using the podcast, users can enjoy contents such as radio programs with ease free from time and space.

To use the podcast, the user installs an RSS reader program for the podcasting to his/her computer or subscribes to a website which provides a web-based reader service. Next, the user subscribes to his/her intended podcast and replays contents automatically updated and downloaded from the subscribed podcaster using the computer or the synchronized portable producing apparatus.

However, the usage of the podcast is so complicated that the user with no expertise cannot easily use the podcast. The user needs to be fully aware of how to operate the computer, how to use the RSS reader of the podcast, and how to operate the portable reproducing apparatus. It is quite hard for the ordinary user to comprehend the series of the usage to use the podcast. Further, even a user with the expertise feels cumbersome in daily synchronizing his/her intended contents at the portable reproducing apparatus.

### SUMMARY OF THE INVENTION

Accordingly, an aspect of the present invention is to provide a reproducing apparatus, a reproducing system, and a reproducing method enabling not only a user with little knowledge about a podcast but also a user with the expertise to reproduce audio and video contents with ease and convenience.

Another aspect of the present invention is to provide a reproducing system including a reproducing apparatus for having a unique product ID code and reproducing contents; and a management server for matching at least one podcast to the product ID code and providing download information based on the at least one podcast to the reproducing apparatus. The reproducing apparatus sends the product ID code to the management server and downloads the contents from a content server based on the download information.

The management server may register the product ID code according to a request from a user terminal and match the at least one podcast to the product ID code according to a selection from the user terminal.

The reproducing apparatus may download the contents from the content server when a predetermined condition based on at least one of a communication network state, a time, and a place is satisfied.

The management server may extract another podcast based on the at least one podcast and provide the download information further based on the another podcast to the reproducing apparatus.

The reproducing apparatus may have a plurality of reproducing channels corresponding to the at least one podcast, and contents of the another podcast may be reproduced on at least one-of the reproducing channels.

The reproducing apparatus may access the management server and the content server over a wireless communication network.

The management server may extract information relating to new contents from a podcast file corresponding to the at least one podcast and the download information may include the extracted information.

According to the aspect of the present invention, a reproducing apparatus includes a communicator for communicating with a management server; and a controller for sending a unique product ID code to the management server through the communicator, receiving download information based on at least one podcast from the management server, downloading contents from a content server based on the download information, and reproducing the contents. The at least one podcast corresponds to the product ID code.

The product ID code may be registered to the management server according to a request from a user terminal, and the at least one podcast may correspond the product ID code according to a selection from the user terminal.

The contents may be downloaded from the content server when a predetermined condition based on at least one of a communication network state, a time, and a place is satisfied.

The reproducing apparatus may have a plurality of reproducing channels corresponding to the at least one podcast, and contents of a podcast recommended from the management server may be reproduced on at least one of the reproducing channels.

The communicator may access the management server and the content server over a wireless communication network.

The reproducing apparatus may further include a channel selector for selecting one of the at least one podcast; and an episode selector for selecting one of episodes of the selected podcast.

According to the aspect of the present invention, a reproducing method of a reproducing system which comprises a reproducing apparatus and a management server communicating with each other, includes registering a unique product ID code to the management server; matching at least one podcast to the product ID code; sending the product ID code to the management server; providing download information based on the at least one podcast to the reproducing apparatus; downloading contents based on the download information; and reproducing the contents.

The registering may be performed according to a request from a user terminal, and the matching may be performed according to a selection from the user terminal.

The downloading may be performed when a predetermined condition based on at least one of a communication network state, a time, and a place is satisfied.

The reproducing method may further include extracting another podcast based on the at least one podcast. The providing may include providing the download information further based on the another podcast to the reproducing apparatus.

The sending and the downloading may be performed over a wireless communication network.

The providing may include extracting information relating to new contents from a podcast file corresponding to the at least one podcast and including the extracted information to the download information.

A computer readable medium contains a program to execute the method at a computer.

### BRIEF DESCRIPTION OF THE DRAWINGS

FIG. 1 is a, block diagram of a reproducing system according to an embodiment of the present invention;

FIG. 2 is a block diagram of a reproducing apparatus according to an embodiment of the present invention;

FIG. 3A is a perspective view of an exterior of the reproducing apparatus according to an embodiment of the present invention, FIGS. 3B and 3C are simplified views of a front panel of the reproducing apparatus according to an embodiment of the present invention; and

FIGS. 4 through 5B are flowcharts of operations of the reproducing system according to an embodiment of the present invention.

### DETAILED DESCRIPTION OF THE EXEMPLARY EMBODIMENTS

Preferred embodiments of the present invention will be described herein below with reference to the accompanying drawings. In the following description, well-known functions or constructions are not described in detail since they would obscure the invention in unnecessary detail.

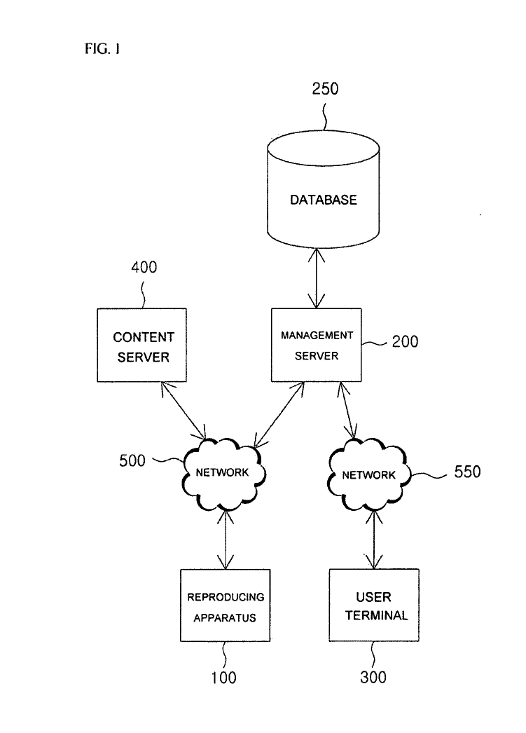

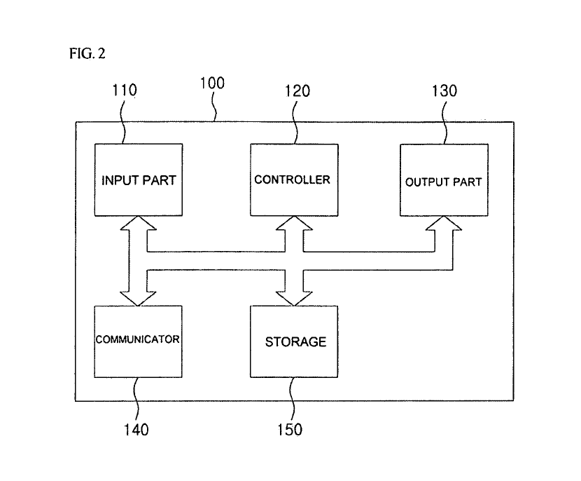

A reproducing apparatus and a reproducing system according to an embodiment of the present invention are described in detail by referring to FIGS. 1 and 2.

FIG. 1 is a block diagram of a reproducing system according to an embodiment of the present invention, and FIG. 2 is a block diagram of a reproducing apparatus according to an embodiment of the present invention.

The reproducing system of FIG. 1 includes a reproducing apparatus 100, a management server 200 connected to the reproducing apparatus 100 via a communication network 500, and a database 250 connected the management server 200. The reproducing system is connected to a plurality of content servers 400 and a user terminal 300 over communication networks 500 and 550, respectively.

The user terminal 300 registers the reproducing apparatus 100 by accessing the management server 200 over the communication network 550, and registers a user identifier (ID) and a password to use the reproducing apparatus 100. The user terminal 300 sets a podcast environment and options about the reproducing apparatus 100, and registers or modifies the podcast to be replayed at the reproducing apparatus 100. It is assumed that a user A I of the user terminal 300 is aware of basic knowledge about the podcast and the computer.

The user terminal 300 includes an application program (not shown) to access the management server 200 and exchange information. For example, the application program can be, but not limited to, a web browser such as Internet Explorer developed by Microsoft. The application program may be a dedicated program downloaded and installed from the management server 200.

The user terminal 300 can be a terminal such as desktop computer, notebook computer, work station, palmtop computer, personal digital assistant (PDA), and web pad, which has an operation capability by including a memory means and a microprocessor.

The communication networks 500 and 550 can be a local area network (LAN), a metropolitan area network (MAN), a wide area network (WAN), and Internet, and can be wired or wireless. A communication scheme of the communication networks 500 and 550 can be any communication scheme such as global system for mobile communication (GSM), code division multiple access (CDMA), wideband-CDMA (WCDMA), wireless LAN (Wi-Fi), Bluetooth, Zigbee, ultra-wideband (UWB), and world interoperability for microwave access (WiMax). If the reproducing apparatus 100 is portable, it is advantageous that the communication network 500 is a wireless communication network.

Each content server 400 offers its unique podcast through the web site of its operator. In detail, the content server 400 offers a podcast file as requested by the management server 200 and offers podcast contents as requested by the reproducing apparatus 100. Note that the operator of the content server 400 may differ from that of the management server 200.

The podcast file includes podcast information relating to a podcast title, a link indicating a location of the podcast contents, and main podcast contents. The podcast file can include content information of a new podcast. The operator of the content server 400 creates new podcast contents and updates the podcast file by adding the information of the new podcast contents to the podcast file. When the content server 400 creates the new podcast contents, the creation of the new podcast contents can be automatically informed to the management server 200. The podcast file can be a really simple syndication or rich site summary (RSS) file which is generated according to a RSS format about the content distribution and aggregation. Alternatively, the podcast file may conform to a communication format called Atom or a separate communication format.

The podcast contents include not only audio contents but also video contents, and may include other multimedia contents.

The management server 200 provides the user terminal 300 with various applications for the usage of the reproducing apparatus 100. The management server 200 controls to register the reproducing apparatus 100, register the user ID and password, and set the environment to use the podcast at the reproducing apparatus 100. Also, the management server 200 offers a list of the entire podcast provided by the content servers 400 so that the user A1 can select and subscribe to the intended podcast, includes the selected podcast to a user podcast list according to the user ID, and stores the user podcast list to the database 250.

The management server 200 registers the web sites of the content servers 400, reads and stores the podcast file of the corresponding web site to the database 250. The management server 200 can generate and store podcast update information to the database 250 by reading the podcast file and separately extracting the information about the new podcast contents. The management server 200 updates the podcast file or the podcast update information stored to the database 250 by periodically reading the podcast files of the content servers 400.

The management server 200 sends download information including the podcast file subscribed by the user and the user podcast list or the podcast update information to the reproducing apparatus 100 so that the reproducing apparatus 100 can download the updated podcast content.

The database 250 contains a product ID code of the reproducing apparatus 100, the user ID and password according to the product ID code of the reproducing apparatus 100, and the environment and option settings and the user podcast list on the user ID basis. The database 250 can store the entire podcast file.

The reproducing apparatus 100 receives the pre-subscribed podcast file or the podcast update information from the management server 200 by accessing the management server 200, downloads and stores the podcast contents by accessing the content server 400. If necessary, the reproducing apparatus 100 can replay the stored podcast contents.

A user A2 of the reproducing apparatus 100 may have no knowledge about the podcast and the computer. Yet, the user A2 can enjoy the podcast contents by simply manipulating the reproducing apparatus 100. Note that the user A1 and the user A2 may be the same person.

The reproducing apparatus 100 is distinguished from another reproducing apparatus 100 with its unique product ID code. The product ID code can be a product serial number or an IP address of the reproducing apparatus 100. Any number for distinguishing the reproducing apparatuses 100 can be used as the product ID code.

The reproducing apparatus 100 of FIG. 2 includes an input part 110, a controller 120, an output part 130, a communicator 140, and a storage 150.

The input part 110 includes a volume controller, a channel selector, and an episode selector which are manipulated by the user A2. The user A2 can regulate the volume of the contents replayed at the reproducing apparatus 100 using the volume controller, select the podcast stored to the reproducing apparatus 100 using the channel selector, and select the separate content of the current podcast using the episode selector.

One channel corresponds to one podcast to replay the corresponding podcast content. The number of the channels can be 10 or so, but can be increased or decreased if necessary. Yet, at least one specific channel can be set to a shuffle channel to randomly replay the entire podcast contents stored to the reproducing apparatus 100, rather than to correspond to the subscribed podcast. At least one specific channel can correspond to the recommended podcast based on the user's liking to replay the corresponding podcast contents. More specifically, the management server 200 can recommend the popular podcast similar to the podcast selected by the user Al, or the popular podcast selected by other users together with the podcast selected by the user Al. Herein, the popular podcast can indicate the podcast selected by many users. The recommended podcast is included to the corresponding user podcast list. This podcast matching function for the specific channel can be selected by the user Al in the option setting.

The number of the episodes can be determined based on the storage capacity of the reproducing apparatus 100. The old episode once replayed can be automatically deleted. This automatic deletion function can be set as optional by the management server 200. The user A1 may select to keep storing the old episode without deleting it.

The communicator 140 exchanges information with the management server 200 and the content server 400 over the communication network 500. The communicator 140 can communicate with the management server 200 and the content server 400 using one of GSM, CDMA, WCDA, Wi-Fi, Bluetooth, Zigbee, UWB, WiMax, and LAN. While the communicator 140 primarily adopts the wireless communications, the wired communication is also possible.

The output part 130 includes a display part such as LED and LCD, a speaker, an audio output port, and a video output port. The display part displays the channel information and/or the episode information reproduced as selected by the user A2. The display part can display the channel information and/or the episode information being selected by the user A2 through the input part 110. The display part may display information or time in relation with the reproducing apparatus 100, or the reproducing podcast video contents. The podcast audio contents may be replayed through the speaker or converted to an audio signal and then output to an external audio reproducing apparatus through the audio output part. The podcast video contents can be converted to a video signal and output to an external display device through the audio and video output ports. Note that part of the output part 130 can be selectively employed in the reproducing apparatus 100 and be omitted if necessary.

The storage 150 contains basic programs to operate the reproducing apparatus 100, the user podcast list and the podcast file or the podcast update information received from the management server 200, and the podcast contents received from the content server 400. The storage 150 can be implemented using a ROM, a RAM, a flash memory, a hard disk drive, and a CF card, or in combination of them.

The controller 120 controls the input part 110, the output part 130, the communicator 140, and the storage 150 to enable the reproducing apparatus 100 to perform various operations. The controller 120 properly operates by interpreting the information received from the management server 200, and plays or shows the podcast contents selected by the user A2 to the user A2.

The reproducing apparatus 100 contains information relating to the last podcast contents replayed on the podcast channel basis for the convenience of the user A2. Once the corresponding channel is selected, the reproducing apparatus 100 controls to replay the last part or the next podcast contents using the information.

The reproducing apparatus 100 can have a remote control function. The user A2 is able to select the podcast, select the podcast contents, and regulate the volume using a remote controller.

The reproducing apparatus 100 supports diverse audio and video formats such as OGG, WMA, WAV, MP3, AVI, WMV, and MOV.

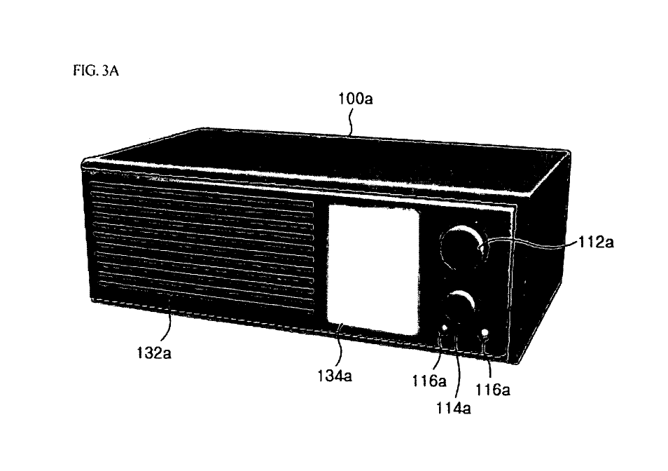

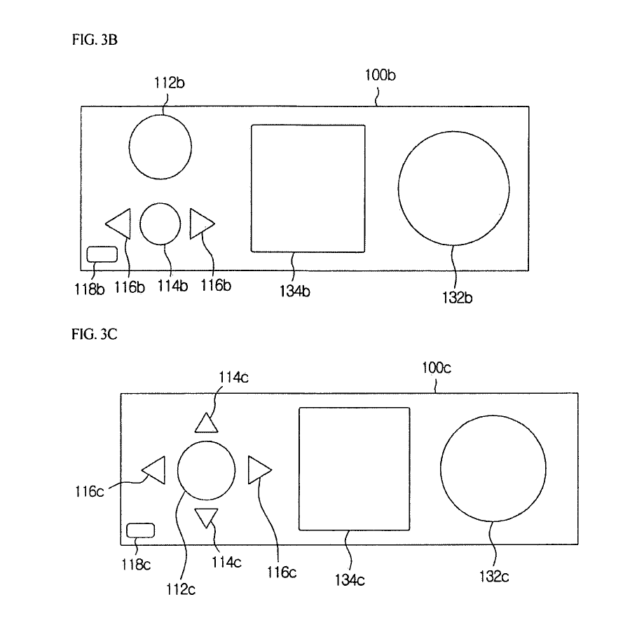

Now, the exterior of the reproducing apparatus is illustrated by referring to FIGS. 3A, 3B and 3C.

FIG. 3A is a perspective view of the exterior of the reproducing apparatus according to an embodiment of the present invention, and FIGS. 3B and 3C are simplified views of a front panel of the reproducing apparatus according to an embodiment of the present invention.

Referring first to FIG. 3A, the reproducing apparatus 100a is formed in a box shape similar to an old radio. On a front panel, a volume control dial 112a, a channel select dial 114a, two episode select buttons 116a, a speaker 132a, and a display part 134a are provided. The user A2 can select his/her intended podcast channel by turning the channel select dial 114a and select his/her intended podcast contents by pressing the episode select buttons 116a.

In FIG. 3A, while the channel select dial 114a is smaller than the volume control dial 112a in size, the channel select dial 114a can have the same size as the volume control dial 112a or the channel select dial 114a can be greater than the volume control dial 112a in size. The two episode select buttons 116a can be disposed between the volume control dial 112a and the channel select dial 114a, or on the right/left side of, above, or under the channel select dial 114a. The size and the arrangement of the channel select dial 114a, the volume control dial 112a, and the episode select buttons 116a may vary.

A power button and audio and video output ports can be provided on a rear side of the reproducing apparatus 100a.

The user A2 is able to select and replay his/her intended podcast contents by manipulating only the channel select dial 114a and the two episode select buttons 116a of the reproducing apparatus 100a. Similar to the listening to the radio or more easily, the user A2 can enjoy the podcast contents by manipulating the reproducing apparatus 100a. In addition, even when the user A1 is using the reproducing apparatus 100a, the podcast contents can be replayed far more easily than the conventional podcast content reproducing method.

When the podcast contents are selected and a predetermined time passes, the selected podcast contents are automatically reproduced. Hence, the reproducing apparatus 100 does not require a separate replay button.

Referring to FIG. 3B, in a reproducing apparatus 100b according to another embodiment of the present invention, a front panel includes a volume control dial 112b, a channel select dial 114b, two episode select buttons 116b, a power button 118b, a speaker 132b, and a display part 134. Unlike the reproducing apparatus 100a of FIG. 3A, the two episode select buttons 116b are separated apart based on the channel select dial 114b, the power button 118b is disposed in the front panel, and the speaker 132b is in a circular form.

In a reproducing apparatus 100c of FIG. 3C according to yet another embodiment of the present invention, a front panel includes a volume control dial 112c, two channel select buttons 114c, two episode select buttons 116c, a power button 118c, a speaker 132c, and a display part 134c. Unlike the reproducing apparatus 100b of FIG. 3B, the two channel select buttons 114c are disposed above and below the volume control dial 112c and the two episode select buttons 116b are disposed on the left and right sides of the volume control dial 112c.

It should be understood that the reproducing apparatuses 100a, 100b and 100c of FIGS. 3A, 3B and 3C are merely examples to show the exterior of the reproducing apparatus 100 of the present invention, and that the exterior can vary.

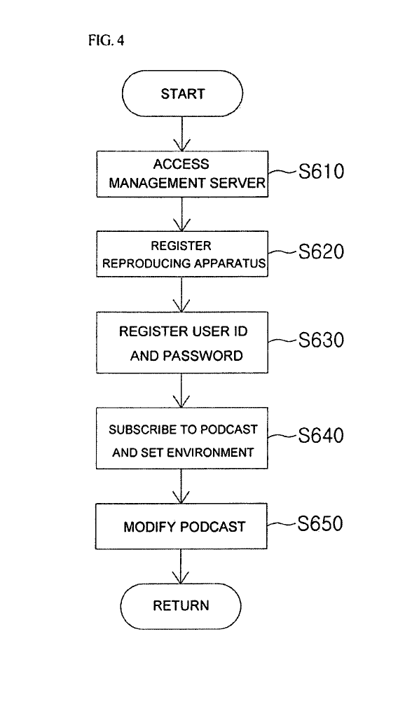

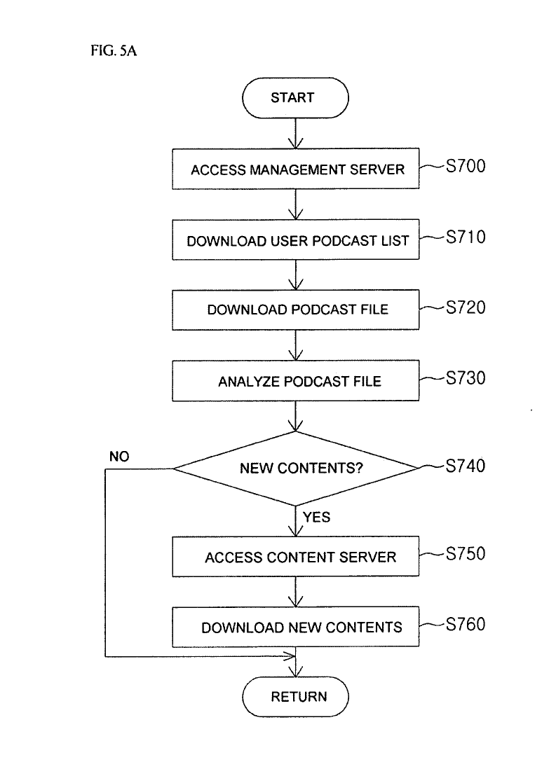

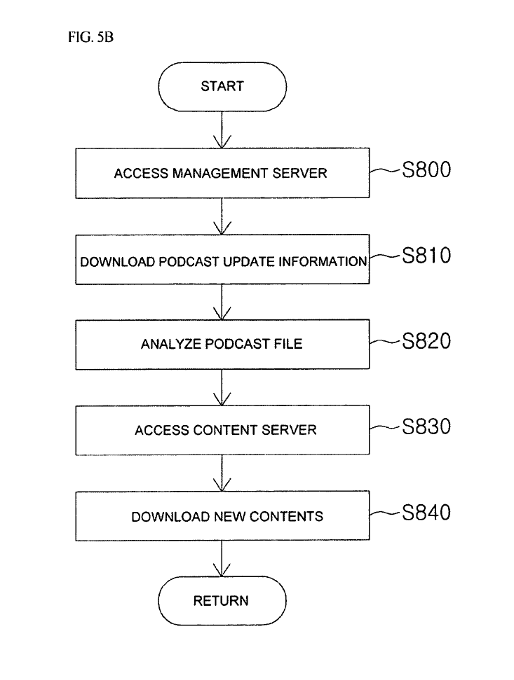

A podcast reproducing method is now explained in detail by referring to FIGS. 4 through 5B.

FIGS. 4 through 5B are flowcharts of operations of the reproducing system according to an embodiment of the present invention. Particularly, FIG. 4 illustrates operations of the user terminal 300 in relation with the management server 200, and FIGS. 5A and 5B illustrate operations of the reproducing apparatus 100 with respect to the management server 200 and the content server 400.

In FIG. 4, the user A1 accesses the management server 200 through the user terminal 300 (S610). The management server 200 provides the user terminal 300 with a web site of a specific web address for the access and the communications with the user terminal 300.

After accessing the management server 200, the user A1 registers the reproducing apparatus 100 to the management server 200 by input the product ID code of the reproducing apparatus 100 (S620), and registers the user ID and the password in association with the reproduction apparatus 100 (S630). The management server 200 stores the product ID code, the user ID, and the password to the database 250. When the user A1 revisits this web site, the registration of the reproduction apparatus (S620) and the registration of the user ID and the password (S630) are omitted and merely the user is authenticated using the registered user ID and password.

The user A1 selects and subscribes to his/her intended podcast among the podcasts supported by the management server 200, and sets the environment and the options (S640). If necessary, the user A1 can modify the podcast by deleting or adding the subscribed podcast (S650). When the podcast subscribed by the user terminal 300 is changed, the management server 200 reflects the change on the user podcast list. Next, when the reproducing apparatus 100 accesses the management server 200, the management server 200 controls the reproducing apparatus 100 to download the new podcast contents based on the updated user podcast list.

Now referring to FIG. 5A, being turned on, the reproducing apparatus 100 accesses the management server 200 (S700). The reproducing apparatus 100 can access the management server 200 by periods, when a predetermined time passes, or at a specific time.

When the reproducing apparatus 100 accesses the management server 200 and sends its product ID code, the management server 200 sends the user podcast list of the user A1 to the reproducing apparatus 100 by referring to the user ID corresponding to the product ID code, and the reproducing apparatus 100 downloads and stores the user podcast list to the storage 150 (S710). The management server 200 extracts the podcast file of the user podcast list from the database 250 and sends the extracted podcast file to the reproducing apparatus 100 and the reproducing apparatus 100 downloads and stores the podcast file to the storage 150 (S720).

The reproducing apparatus 100 analyzes the podcast file stored to the storage 150 and the new podcast file received from the management server 200 (S730) and determines whether new podcast contents are created (S740). When the new podcast contents are created, the reproducing apparatus 100 access the content server 400 of the new podcast contents (S750) and downloads the new podcast contents (S760). Hence, the user A2 can replay and enjoy the new podcast contents.

Referring to FIG. 5B, as described earlier, when the power is on or the time passes, the reproducing apparatus 100 accesses the management server 200 (S800).

When the reproducing apparatus 100 accesses the management server 200 and sends its product ID code, the management server 200 sends the podcast update information of the user ID corresponding to the product ID code to the reproducing apparatus 100 and the reproducing apparatus 100 downloads and stores the podcast update information to the storage 150 (S810). When the podcast update information contains no information about the new podcast contents, the management server 200 informs the reproducing apparatus 100 of no new podcast contents without sending the podcast update information to the reproducing apparatus 100.

The reproducing apparatus 100 analyzes the received podcast update information (S820), accesses the content server 400 of the new podcast contents (S830), and then downloads the new podcast contents (S840).

In FIG. 5A, the management server 200 sends the podcast file collected from the content server 400 to the reproducing apparatus 100 and the reproducing apparatus 100 determines whether there are new podcast contents by analyzing the podcast file. By contrast, in FIG. 5B, the management server 200 analyzes the podcast file collected from the content server 400 and determines whether there are new podcast contents and the reproducing apparatus 100 downloads the relevant contents according to the podcast update information. Either the operations of FIG. 5A or the operations of FIG 5B can be selectively performed. The operations of FIG. 5B can reduce the load of the reproducing apparatus 100 and the amount of the data transmitted between the management server 200 and the reproducing apparatus 100, compared to the operations of FIG. 5A. When the reproducing apparatus 100 does not support the data format used at the content server 400, the management server 200 is able to convert the data format to a proper data format and send the converted data format to the reproducing apparatus 100.

Meanwhile, the reproducing apparatus 100 can be used far away from the user terminal 300. When the user A1, who is far away, registers his/her intended podcast to the management server 200 using the user terminal 300, the reproducing apparatus 100 can download the corresponding podcast contents from the content server 400. Accordingly, the user A2 can enjoy the podcast contents by merely pressing several buttons of the reproducing apparatus 100.

The reproducing apparatus 100 may be used at home like a radio, and in a car like a MP3P.

When a predetermined condition is satisfied based on at least one of the state of the communication network 500, the time, and the place, the reproducing apparatus 100 downloads the new podcast contents by accessing the content server 400. Using the GSM or the CDMA, when the state of the communication network 500 is good, the reproducing apparatus 100 accesses the content server 400 and downloads the new podcast contents to save the limited frequency resources. For instance, when the number of users of the communication network 500 falls below a reference value over a predetermined time, the reproducing apparatus 100 can access the content server 400. Such a condition is determined at a base station of a communication service provider of the corresponding communication network 500. When the condition is satisfied, the base station issues a communication allowance signal to the reproducing apparatus 100. Upon receiving the communication allowance signal, the reproducing apparatus 100 can commence the content downloading. The condition is met mostly in midnight. Besides, the download can be allowed only at a specific time. If the reproducing apparatus 100 is used in the car, the contents can be downloaded only during the parking in the parking lot. Note that the condition may be overlapped. As such, the communication cost can be reduced by limiting the downloading.

If the reproducing apparatus 100 cannot download the podcast contents in a specific situation, the management server 200 can provide the problematic situation by means of an e-mail or a cellular phone of the user A1. Regardless of the user A2, the user A1 can recognize the problematic situation and take a proper action.

When the management server 200 downloads the new podcast contents from the content server 400 in advance and the reproducing apparatus 100 accesses the management server 200, the management server 200 can send the podcast contents to the reproducing apparatus 100. In this case, the management server 200 can convert the data format of the podcast contents received from the content server 400 to a suitable format of the reproducing apparatus 100 and the audio file can be arbitrarily inserted to inform of the podcast title, to thus enhance the user convenience.

The reproducing apparatus 100 can be dedicated for an educational device. In place of the user terminal 300, the management server 200 can select and subscribed to the educational contents in accordance with the progress of the studying. In place of the content server 400, the management server 200 can create and offer the educational contents. Accordingly, the reproducing apparatus 100 can be utilized without the user terminal 300 and the content server 400. In this situation, the management server 200 is an educational institute and the user of the reproducing apparatus 100 is an educatee. It is possible to protect all the contents of the content server 400 using a digital rights management (DRM).

The embodiment of the present invention include a computer readable medium including program commands to execute various computer operations. The computer readable medium contains a program to execute the content reproducing method of the present invention. The computer readable medium can contain alone or in combination of program commands, data files, and data structures. Examples of the computer readable means include magnetic media such as hard disk, floppy disk, and magnetic tape, optical recording media such as CD and DVD, floptical disks and magneto optical media, and hardware devices such as ROM, RAM, and flash memory capable of storing and executing the program commands. Alternatively, the medium can a transmission medium, such as optical or metallic cable and waveguide, which includes carrier waves carrying signals indicative of the program command and the data structure. Examples of the program command include not only machine language codes created by the compiler but also high-level language codes executable at the computer using the interpreter.

As set forth above, the reproducing apparatus, the reproducing system, or the reproducing method enables not only the user with little knowledge about the podcast but also the user with the expertise to replay and enjoy the podcast audio and video contents with ease and convenience.

While the invention has been shown and described with reference to a few exemplary embodiments thereof, it will be understood by those skilled in the art that various changes in form and details may be made therein without departing from the spirit and scope of the invention as defined by the appended claims.

What is claimed is:

1. A reproducing system comprising:
a reproducing apparatus for having a unique product ID code and reproducing contents; and
a management server for matching at least one podcast to the product ID code and providing download information based on the at least one podcast to the reproducing apparatus,
wherein the reproducing apparatus sends the product ID code to the management server and downloads the contents from a content server based on the download information.

2. The reproducing system of claim 1, wherein the management server registers the product ID code according to a request from a user terminal and matches the at least one podcast to the product ID code according to a selection from the user terminal.

3. The reproducing system of claim 1, wherein the reproducing apparatus downloads the contents from the content server when a predetermined condition based on at least one of a communication network state, a time, and a place is satisfied.

4. The reproducing system of claim 1, wherein the management server extracts another podcast based on the at least one podcast and provides the download information further based on the another podcast to the reproducing apparatus.

5. The reproducing system of claim 4, wherein the reproducing apparatus has a plurality of reproducing channels corresponding to the at least one podcast, and contents of the another podcast are reproduced on at least one of the reproducing channels.

6. The reproducing system of claim 1, wherein the reproducing apparatus accesses the management server and the content server over a wireless communication network.

7. The reproducing system of claim 1, wherein the management server extracts information relating to new contents from a podcast file corresponding to the at least one podcast and the download information includes the extracted information.

8. A reproducing apparatus comprising:
a communicator for communicating with a management server; and
a controller for sending a unique product ID code to the management server through the communicator, receiving download information based on at least one podcast from the management server, downloading contents from a content server based on the download information, and reproducing the contents,
wherein the at least one podcast corresponds to the product ID code.

9. The reproducing apparatus of claim 8, wherein the product ID code is registered to the management server according to a request from a user terminal, and the at least one podcast corresponds the product ID code according to a selection from the user terminal.

10. The reproducing apparatus of claim 8, wherein the contents are downloaded from the content server when a predetermined condition based on at least one of a communication network state, a time, and a place is satisfied.

11. The reproducing apparatus of claim 8, wherein the reproducing apparatus has a plurality of reproducing channels corresponding to the at least one podcast, and contents of a podcast recommended from the management server are reproduced on at least one of the reproducing channels.

12. The reproducing apparatus of claim 8, wherein the communicator accesses the management server and the content server over a wireless communication network.

13. The reproducing apparatus of claim 8, further comprising:
a channel selector for selecting one of the at least one podcast; and
an episode selector for selecting one of episodes of the selected podcast.

14. A reproducing method of a reproducing system which comprises a reproducing apparatus and a management server communicating with each other, the method comprising:
registering a unique product ID code to the management server;
matching at least one podcast to the product ID code;
sending the product ID code to the management server;
providing download information based on the at least one podcast to the reproducing apparatus;
downloading contents based on the download information; and
reproducing the contents.

15. The reproducing method of claim 14, wherein the registering is performed according to a request from a user terminal, and
the matching is performed according to a selection from the user terminal.

16. The reproducing method of claim 14, wherein the downloading is performed when a predetermined condition based on at least one of a communication network state, a time, and a place is satisfied.

17. The reproducing method of claim 14, further comprising:
extracting another podcast based on the at least one podcast,
wherein the providing comprises providing the download information further based on the another podcast to the reproducing apparatus.

18. The reproducing method of claim 14, wherein the sending and the downloading are performed over a wireless communication network.

19. The reproducing method of claim 14, wherein the providing comprises:
extracting information relating to new contents from a podcast file corresponding to the at least one podcast and including the extracted information to the download information.

20. A computer readable medium comprising a program to execute the method of claim 14 at a computer.
